(19) United States
(12) Patent Application Publication
(10) Pub. No.: US 2023/0415334 A1
(43) Pub. Date: Dec. 28, 2023

(54) MULTI-MEMBERED ACTUATED KINEMATIC SYSTEM

(71) Applicant: ROBCORE GMBH, Hannover (DE)

(72) Inventors: Nico Angerstein, Hannover (DE); Christoph Kremsier, Hannover (DE); Patrick Laza, Hannover (DE); Eugen Lucher, Lindhorst (DE); Andreas Schoob, Hannover (DE)

(21) Appl. No.: 18/039,181

(22) PCT Filed: Nov. 15, 2021
(86) PCT No.: PCT/EP2021/081722

§ 371 Date: May 26, 2023

(30) Foreign Application Priority Data
Nov. 26, 2020 (DE) 10 2020 131 338.1

(51) Int. Cl. B25J 9/16; B25J 19/00; B25J 9/04; G05B 19/414

(52) U.S. Cl. CPC B25J 9/161; B25J 19/0029; B25J 9/04; G05B 19/4141; B25J 9/1664; G05B 2219/33162; G05B 2219/33214; G05B 2219/33218; G05B 2219/33221; G05B 2219/33226; G05B 2219/40237; G05B 2219/40584

(57) ABSTRACT

The present invention relates to multi-limb actuated kinematics (1) having a plurality of drive units (11-16) connected to one another as a serial kinematic chain, the drive units (11-16) respectively having a control unit (11b, 12b, 16b), which are designed to operate at least one drive (11c, 12c, 16c) of the drive unit (11-16) to carry out the movement of the drive unit (11-16), the control units (11b, 12b, 16b) of the drive units (11-16) being connected to one another by a first data line (A₁₀, A₁₁, A₁₂, A₁₃, A₁₆, A₁₇) such that they transmit signals and being designed to receive at least data for operating the drive (11c, 12c, 16c) via the first data line (A₁₀, A₁₁, A₁₂, A₁₃, A₁₆, A₁₇). The multi-limb actuated kinematics (1) are characterised in that the control units (11b, 12b, 16b) of the drive units (11-16) are further connected to one another by a second data line (B₁₀, B₁₁, B₁₂, B₁₃, B₁₆, B₁₇, B₁₉) such that they transmit signals and are designed to forward the data of the second data line (B₁₀, B₁₁, B₁₂, B₁₃, B₁₆, B₁₇, B₁₉).

The present invention relates to multi-limb actuated kinematics according to the preamble of claim 1, to a drive unit for use in such multi-limb actuated kinematics according to claim 14 and to a control unit for use in such a drive unit according to claim 15.

In many technical fields, and in other fields, multi-limb actuated kinematics have long been used to relieve humans of mechanical work, or at least to make this work easier for them. Depending on their use and embodiment, such multi-limb actuated kinematics can be described as an automation system or as robots. Multi-limb actuated kinematics always have several drives and limbs that can also be described as axles, wherein a drive and a limb in combination can also be described as a drive unit. Such drive units can be combined to form multi-limb or multi-axle drive systems or multi-limb actuated kinematics that can carry out multi-dimensional movements and correspondingly more complex series of movements or follow trajectories. Such drive systems can also be described as mechatronic systems.

Multi-limb actuated kinematics as robots are particularly widespread in the industry as articulated arm robots, and thus articulated arm robots can also be described as industrial robots. An articulated arm robot is usually a six-axle multi-limb actuated kinematic system with a spherical or hemi-spherical working space around it, for which reason articulated arm robots can be used very flexibly. An articulated arm robot usually extends from a fixed base over six limbs or over six drive units as a serial kinematic chain up to an end effector that can interact with the environment, for example as a gripper, such that the base, the six drive units and the end effector or an end effector unit form the elements or limbs of the serial kinematic chain. The base of the articulated arm robot can be fixed or non-displaceable or able to be moved or driven in a mobile manner to increase the possible uses of the articulated arm robot. The tool that serves as an end effector can usually be changed depending on use. The programming of the articulated arm robot can further be adapted to the use without the need to alter the articulated arm robot itself, which can make it very adaptable. Articulated arm robots with fewer than six axles are also known, however, which correspondingly can take up fewer poses in the work space, but can thus be produced more easily and cheaply, e.g., as fewer drives must be used, operated and controlled or regulated. Articulated arm robots can also have more than six axles to increase dexterity or increase movement possibilities.

In recent years, robots, and in particular articulated arm robots, have been developed to work directly with people, e.g. during assembly, programming or teaching. Thus, the term “collaborative robot”, or cobot for short, has developed. Both mechanical boundaries such as grid walls, which were previously standard to split the working space of the robot from the environment in which people can be located, and light barriers, light grids and the like, which can at least recognise when a person enters the working space of the robot, are not required. Rather, people can more freely in relation to the robot.

For multi-limb actuated kinematics, and in particular for robots or articulated arm robots, the limbs or the drive units are usually designed such that each drive unit can be connected at one end to the base or to a drive unit of the serial kinematic chain lying ahead and at the opposite end to a following drive unit or to the end effector or to an end effector unit. The drive of the drive unit can respectively carry out a movement relative to a further element of the serial kinematic chain, such that a partial region of the drive unit can move relative to the remaining drive unit.

The drive can usually have an electric motor and in particular an electric motor working by rotation in combination with a gearing to bring about such relative movements. Depending on the arrangement of the drive of the drive unit, one partial region of the drive unit can be described as on the output side and the other partial region of the drive unit can be described as on the drive side. The relative movement can be translational or rotational depending on the embodiment of the multi-limb actuated kinematics, wherein for automated systems, both translational and rotational drive units are usually used, but for robots, and in particular for articulated arm robots, only rotational drive units are usually used.

The end effector or the end effector unit can always be moved in a targeted manner in relation to the base of the multi-limb actuated kinematics and be positioned and oriented in space. The position of a drive unit or the end effector or the end effector unit should be understood to mean the place within a Cartesian coordinate system at which the drive unit or the end effector or the end effector unit is located in a geometric space. The positioning of a drive unit or the end effector or the end effector unit is understood as assuming a concrete spatial location. Orienting a drive unit or the end effector or the end effector unit is understood as the alignment of the drive unit or the end effector or the end effector unit in relation to the axes of a Cartesian coordinate system. Assuming an orientation of a drive unit or the end effector or the end effector unit is understood as changing the current orientation of the drive unit or the end effector or the end effector unit by rotation around the corresponding axes of a Cartesian coordinate system in a desired orientation. Position and orientation can be described together as a pose, location or as a configuration. A trajectory of a drive unit or the end effector or the end effector unit is a movement of the drive unit or the end effector or the end effector unit in space along a path while taking its temporal progression into consideration. A trajectory can also be described as a path curve. The path without temporal reference can also be described as a pathway.

In particular in the case of robots, most particularly in the case of articulated arm robots, it is known to provide a control unit on the base and per drive unit, which control unit can also be described as a regulation unit. This control unit can for example be arranged on the drive side and make a request of at least one position sensor of the drive side to be able to determine the positioning of the partial region of the drive unit on the output side in relation to the partial region of the drive unit on the drive side. Depending on the positioning recorded by the sensor, the drive of the drive unit can be operated by the control unit and in particular be set to a predetermined position or angular position. Further sensors in the control unit, such as strain gauges in the drive unit, can also be evaluated. This can similarly be the case for the base of the multilimb actuated kinematics. The control units of the drive units or the control unit of the base can thus also be described as decentralised control units.

To allow all the drives of the drive units of the multi-limb actuated kinematics to coordinate with one another, and thus to allow the end effector or the end effector unit to take up the desired pose in relation to the base, the control units of the drive units must be coordinated. This usually occurs in a superordinate central control unit of the multi-limb actuated kinematics that is connected to all the control units of the drive units and optionally to the control unit of the base such that it can transmit data. This usually occurs by means of a so-called field bus, via which the central control unit can bi-directionally communicate with all the decentralised control units so that it can send both information and instructions as data from the superordinate central control unit to the individual decentralised control units of the drive units, and at least receive information as data from there. Modbus and EtherCAT are used as such serial field buses, for example.

For robots, and in particular for articulated arm robots, it is known to operate additional devices in the region of the end effector or on the end effector unit to increase the usage possibilities of the robot or to exploit new fields of use. In particular, cameras can be used to optically record the region in front of the end effector, and thus to enable the perception of the environment via the robots. Such a camera can be seen as an example of a data processing unit, as the camera can be operated or controlled by the robot on the one hand, and on the other can generate and transmit optical information as optical data, i.e., as data that represents optical information. Such a camera and the like can be arranged on a separate component, which can be arranged between the last limb or the last drive unit and the end effector, in particular fixed with the end effector, and can be described as a connecting element or as a media flange. The connecting element or the media flange and the end effector can also be described in combination as an end effector unit.

To operate a data processing unit, for example in the form of the previously described camera in the region of the end effector or on the end effector unit, it is thus required on the one hand to supply the camera with electricity, which can be achieved by connecting the camera to the electrical supply of the robot. On the other hand, bi-directional communication between the robot and the camera is required to be able to transmit control data for example from the superordinate central control unit to the camera and to be able to transmit the recorded optical image data as optical data, i.e., as data representing optical information, away from the camera to the superordinate central control unit.

For this purpose, it has been usual to guide an additional data and supply cable from the camera along the serial kinematic chain of the drive units of the robot to its superordinate central control unit and to connect it there to the superordinate central control unit both such that it transmits signals and such that it transmits voltage. The camera can thus be supplied with power directly from the central control unit. Both the control data or instructions and the image data or optical data can further be exchanged directly between the superordinate central control unit and the camera of the end effector unit.

Here it is disadvantageous, however, that such an additional data and supply cable is usually guided as an external cable on the outside of the drive units of the robot and is fixed to the housings of the drive units from outside, which is usually done manually by a person. This represents additional complexity when producing or when assembling the robot. The external cable must also be laid between the partial regions of the drive and the partial regions of the output of the individual drive units sufficiently loosely or in loops so that the external cable does not hinder the relative movements of the drive units relative to one another or is not tom off as a result. Such an external cable can thus represent a danger when using the robot, however, as objects or even people can be caught in the loops of the external cable. Even in the case of a larger embodiment of the loop of the external cable, the freedom of movement and thus the work space of the robot can additionally be limited. Furthermore, the external cable can be perceived as visually annoying by users, in particular due to its loops.

Alternatively, it is therefore known to lay an additional data and supply cable, for example of a camera, through the drive units of the robot to avoid an external cable as previously described. As the drive units of such robots, and in particular of such articulated arm robots, usually have drives having electric motors and hollow shaft gearings for causing rotational relative movements as previously described, the field bus cable as a data cable and the electrical supply cable of the drive units are usually already guided through the hollow shafts of the drives, however, such that no or only a very low installation space is available through the hollow shafts of the drives for a further data and supply cable of the camera or another data processing unit of the end effector or the end effector unit.

If sufficient installation space is available for a further data and supply cable of the camera at all, the movements of the drives are made more difficult and slowed by the correspondingly high stiffness of the cable harness of all the cables in combination. The cables can also now rub more strongly against one another and/or against the insides of the hollow shafts, which can cause abrasion of the cable or even cable breakage or a reduced lifespan of the cable. Thus, the more cable is guided through a hollow shaft, the larger or stronger these effects can occur.

Furthermore, the cables can interfere with one another when transmitting signals due to EMC problems (electromagnetic compatibility). This applies in particular to the electrical supply cable, which can interfere with the signal transmission of the data cables of the drive units and/or the camera.

One object of the present invention is to provide multi-limb actuated kinematics, and in particular a robot, most particularly an articulated arm robot, of the kind described in the introduction, such that data transmission can be carried out via the drive units more easily than previously known. In particular, the bi-directional transmission of data between a superordinate central control unit of the multi-limb actuated kinematics and a data processing unit of an end effector unit of the multi-limb actuated kinematics can be simplified. In particular, as an alternative or in addition, the electrical supply of an image processing unit of the end effector unit is intended to be simplified and/or improved with regard to the multi-limb actuated kinematics. An alternative to known such multi-limb actuated kinematics should at least be provided.

The object is solved according to the invention by multi-limb actuated kinematics having the features of claim 1, by a drive unit having the features of claim 14 and by a control unit having the features of claim 15. Advantageous developments are described in the sub-claims.

The invention thus relates to multi-limb actuated kinematics having a plurality of drive units connected to one another as a serial kinematic chain. Such a serial kinematic chain can consist of at least two drive units connected to one another and able to carry out a movement in relation to each other by means of a drive of one of the two drive units. Such a movement can preferably be rotational. More than two drive units can also be used. Preferably, at least six drive units, and most particularly exactly six drive units can be combined as a serial kinematic chain to form multi-limb actuated kinematics. Such multi-limb actuated kinematics can in particular be employed as robots and most particularly as industrial robots or as articulated arm robots. Such multi-limb actuated kinematics can for example be used in industry in particular to take on tasks in assembly, in finishing, in logistics and when packing and commissioning wares.

One drive unit can always be arranged fixed relative to the other drive unit, which can for example be achieved on a foundation, e.g., a base, a wall, a ceiling or the like. For this purpose, this drive unit can be connected moveably in relation to a base, which can be fixedly arranged on the foundation. However, the foundation can also always be designed to be mobile, e.g., in the form of a vehicle on or in which this drive unit or the base can be fixedly arranged.

The movements of the drive units can be caused respectively by means of a drive as described in the introduction. For this purpose, drives working by rotation can in particular be used as already previously mentioned. A hydraulic or a pneumatic pressure can also be used as a drive force, wherein electrical energy can be preferred for generating the drive force. The movement can be caused directly by a corresponding motor or indirectly via gearings. Electric motors can in particular be used as motors and hollow shaft gearings can in particular be used as gearings. The position of the part of the respective drive on the drive side and on the output side can be recorded by a position sensor, e.g. by an angle sensor in the case of rotary drives, such that a relative position of the part on the drive side and on the output side of the respective drive can be recorded by sensors. A torque sensor can optionally also be present.

The drive units respectively have a control unit designed to operate at least one drive of the drive unit to carry out the movement of the drive unit. Such a control unit can for example be designed as a circuit board having corresponding electronic components that can be fixedly arranged within a housing of the drive unit, preferably on the drive. Such control units per drive unit can also be regarded as decentralised control units.

The control units of the drive units are connected to one another by a first data line such that they transmit signals and are designed to receive at least data for operating the drive via the first data line. The control units of the drive units can be connected with at least one superordinate central control unit such that they transmit signals via the first data line. Such a signal transmission can preferably be achieved via a field bus, e.g., via a serial ethernetCAT bus that connects the control units of all the drive units to one another and preferably further to the superordinate central control unit such that they transmit signals.

Actuation of the electrical or electronic functions of the respective drive unit can respectively be achieved by the control units of the drive units. The respective drive can in particular be controlled or positioned by the control units. Operating or reading a position sensor of the respective drive unit can further preferably be carried out. Correspondingly, data in the form of instructions, commands or control data can be received and used by the control unit of the respective drive unit. In the opposite direction, data in the form of information or sensor data e.g., of the position sensor of the drive unit can be transmitted and for example made available to the superordinate central control unit by the control unit of the respective drive unit. The superordinate central control unit can determine a pose of the multi-limb actuated kinematics from such position information of all the drive units using a kinematic model of said multi-limb actuated kinematics, and transmit corresponding instructions via the first data line to the control units of the drive units to change the pose.

The multi-limb actuated kinematics according to the invention are thus characterised in that the control units of the drive units are further connected to one another by a second data line such that they transmit signals, and are designed to forward the data of the second data line.

In other words, the control units of the drive units of the drive units of the multi-limb actuated kinematics according to the invention are connected to one another by two different data lines such that they transmit signals, the data lines respectively being designed to transmit signals representing data. The data lines can have a corresponding number of wires or conductors for this purpose, which together respectively form the data line, which can also be described as a cable. The data lines can also have a plurality of individual lines or cables arranged or connected in series for this purpose. The signal transmission can be achieved electrically or also optically, wherein electrical transmission can be preferred for reasons of simplicity.

The first data line is thus connected to the control units of the drive units such that they transmit signals such that data can at least be received in particular in the form of control data, instructions or commands by the control units of the drive units. Optionally, this data can also be forwarded by the respective control unit if this data is not directed to the respective control unit, as can for example be the case for a bus system. As an alternative or in addition, data in the form of information or sensor data can be sent or transmitted from the respective control unit via the first data line. The control units of the drive units are always designed to read the data which they receive via the first data line and to check at least to an extent whether this incoming data is meant for the control unit or not. Depending on this consideration, the incoming data is then further processed by the respective control unit for itself or forwarded via the first data line.

This can preferably be carried out by the control units of the drive units respectively having a first data line input connector connected to a cable of the first data line such that it transmits signals, and by the control units of the drive units respectively having a first data line output connector connected to a further cable of the first data line such that it transmits signals, wherein the control units of the drive units are respectively designed to receive at least data for operating their drive via the first data line and to forward data to operate a drive of another drive unit via the first data line.

Contrastingly, the second data line is connected to the control units of the drive units such that it transmits signals such that data, in particular in the form of sensor data or information, does not reach the electronic components of the control unit and can be processed or used there. Instead, data is received or accepted from the respective control unit via the second data line only in the form that this data is passed on unchanged in its content directly via the second data line. With respect to the data of the second data line, the control units of the drive units thus serve only to physically connect or couple the second data line, which can preferably be carried out in that a cable of the second data line is connected to the respective control unit and ends and a further cable of the second data line is connected to this control unit and begins.

As an alternative or in addition, this can preferably be carried out by the control units of the drive units respectively having a second data line input connector connected to a cable of the second data line such that it transmits signals, and by the control units of the drive units respectively having a second data line output connector connected to a further cable of the second data line such that it transmits signals, wherein the control units of the drive units are respectively designed to receive all data regardless via the second data line.

The present invention is thus based on the knowledge that presently, such first data lines are used in the case of multi-limb actuated kinematics, e.g., for articulated arm robots, as described in the introduction, to connect the decentralised control unit of the drive units with a superordinate central control unit such that it transmits signals and thus to transmit the corresponding sensor data and instructions as data in both directions, which are required to operate or to position the multilimb actuated kinematics themselves. For this purpose, it can also be appropriate for data received via the first data line to be amplified, processed and/or filtered. To transmit additional data e.g., of a camera arranged on the end effector, additional data lines are used, which are guided in parallel to the serial kinematic chain of the drive units either along the outside or through the drive units on the inside, as described in the introduction, which can lead to the disadvantages specified in the introduction.

Such known data lines, which always have further wires for transmitting electrical energy in addition to the wires for transmitting the signals of the data, always completely bypass the control units of the drive units of the multi-limb actuated kinematics, i.e., run physically independently of the control units of the drive units and in particular do not come into contact with the control units of the drive units. In addition to the disadvantages described in the introduction, this can further lead to the laying or the assembly of such a known additional data line in one piece, i.e., integrally as one part over its entire length, through all the drive units representing a significant complexity. In particular, this can make repairing or exchanging an individual drive unit within the serial kinematic chain significantly harder or prevent it if the known additional data line should not be severed such that it is destroyed.

According to the invention, the second data line, which, in comparison with such known data lines, serves to transmit data past the drive units, is therefore connected to the respective control units of the drive units such that it transmits signals, whereby the second data line according to the invention can be constructed in sectional pieces which preferably respectively connect exactly two drive units immediately neighbouring one another or connect their control units to one another such that they transmit signals.

It is also advantageous here that the two different data lines can be coordinated with regard to the number of their wires or conductors to the quantities or kinds of data to be transmitted or their signals, which can improve the quality of the data transmission or the signal transmission and/or keep the required installation space for the data lines to a minimum.

It is further advantageous that different kinds of data, such as instructions, commands or control data, can be transmitted on the first the first data line and data such as information or sensor data can be transmitted on the second data line physically separated from each other. This can increase or guarantee the quality of the respective data transmission such that a required quality of the respective data transmission can be reached or maintained. This can also reduce or avoid a temporal delay in the transmission of the respective data, as the data can respectively be transmitted via a separate data line, which can also be designed or operated adjusted to the respective data volumes. This comprises the cable of the respective data line itself and optionally the corresponding connectors or electronic components of the control units, which are connected to the respective data line such that they transmit signals and enable the signals to be generated and sent.

At least the second data line is thus preferably formed by a plurality of individual cables, which are respectively arranged exactly between the control units of two drive units immediately neighbouring one another, the cables respectively being connected on their ends to the respective control unit such that they transmit signals. This connection can preferably be carried out by a releasable plug connection, which can simplify and accelerate the assembly and the repair or the exchange of the drive units.

In the second data line, an electrical supply line belonging to the latter is preferably not required as is known from known data lines as described in the introduction in order to be able to provide an electrical supply for example of a camera of the end effector independently of the drive units of the multi-limb actuated kinematics in addition to the data transmission. This, however, leads to a correspondingly thick design of such known data lines, which can hinder assembly and operation as described in the introduction. The electrical supply line of such known data lines can also have a disruptive effect on the signal transmission of such known data lines and known first data lines. Thus, for the second data line according to the invention, preferably dispensing with wires for transmitting an electrical supply voltage can both keep the required installation space for laying the second data line to a minimum and avoid disrupting influences of the electrical supply voltage on the transmission of the signals via the second data line.

According to an aspect of the invention, the first data line is formed between two immediately neighbouring control units of the drive units by at least one cable, the second data line is formed between two immediately neighbouring control units of the drive units by at least one cable, and the cable of the first data line and the cable of the second data line are at least partially surrounded by a shared shield. The two data lines can thus be correspondingly shielded to reduce or even to prevent disrupting influences for example in an electrical supply line on the transmission of the signals via the two data lines. Simultaneously, the complexity of the shield can be kept lower due to the shared shield than if the two data lines respectively had their own shield. The required installation space can thus also be kept to a minimum.

According to a further aspect of the invention, the control units of the drive units are further connected to one another such that they transmit electrical energy via a supply line, and are designed both to receive the received electrical energy at least for operating the drive and to forward the received electrical energy. In this way, electrical energy can be made available to the control units of the drive units both to operate or to supply electronic components of the control units and also to operate a respective electric drive. Such an electrical supply can run by means of the supply line through the control units as a closed circuit.

This can preferably be carried out in that the control units of the drive units respectively have a supply line input connector connected to a cable of the supply line such that it transmits electrical energy and that the control units of the drive units respectively have a supply line output connector connected to a further cable of the supply line such that it transmits electrical energy.

According to a further aspect of the invention, the multi-limb actuated kinematics have an end effector unit having an end effector and having a connecting element which is connected by a drive unit on an end of the serial kinematic chain of the drive units, the connecting element having at least one data processing unit, preferably an image recording unit, and a control unit, the control unit of the connecting element being designed to operate at least the data processing unit, the control unit of the connecting element being connected to the first data line such that it transmits signals and being designed to receive at least data for operating the data processing unit, and preferably for operating the end effector, via the first data line, and the control unit of the connecting element further being connected to the second data line such that it transmits signals and being designed to forward the data of the data processing unit via the second data line.

A device for interacting with the environment, for example in the form of a gripper, a sucker or the like can be regarded as an end effector, which can be positioned, oriented and moved by means of the drive units of the multi-limb actuated kinematics. Such an end effector can be arranged on a connecting element, preferably such that it can be exchanged, which can serve as the mechanical connection between the actual end effector and the last limb of the serial kinematic chain of the drive units of the multi-limb actuated kinematics. Such a connecting element can also be described as a media flange, as an end effector flange, As a tool flange or as a gripping flange. The end effector and the connecting element can be connected to one another and be described in combination as an end effector unit. The connecting element or the end effector unit can be moveable in relation to that drive unit that forms the last limb of the serial kinematic chain of the multi-limb actuated kinematics. Such a movement can preferably be achieved by rotation. Such a movement can preferably always take place in the drive unit.

In addition to the end effector, a data processing unit can additionally be arranged on the connecting element or built or integrated into the connecting element to carry out additional functions in the end effector unit. For this purpose, the data processing unit can preferably be designed as an image recording unit for optically recording optical data in the form of images in the region of the end effector unit and preferably directly in front of the end effector. The control unit of the connecting element can serve only to operate the data processing unit or additionally the end effector unit.

If, for known articulated arm robots as described in the introduction, the data of such cameras that are arranged in the region of the end effector is transmitted via a known data line on the outside past the housings of the drive units or through the drive units as described in the introduction, this can be dispensed with according to the invention, and the corresponding disadvantages can be avoided or at least reduced. For this purpose, data in particular in the form of instructions, commands or control data can be transmitted via the first data line of the drive unit as a last limb of the serial kinematic chain of the multi-limb actuated kinematics to the control unit of the connecting element. At least the data processing unit and optionally additionally the end effector can thus be controlled or operated. Furthermore, the data, such as in particular information or sensor data which can be optical data or image data in the case of an image recording unit being used, can be received by the control unit of the connecting element from the data processing unit and forwarded or sent out via the second data line. This can enable the data, which is required to operate the data processing unit, and optionally also the end effector unit, to be sent via the first data line and to be separated from the data of the second data line, which is generated by the data processing unit, preferably as an image recording unit, and can be transmitted via the control units of the drive units away for example to a superordinate central control unit.

This can preferably be carried out by the control unit of the connecting element having a first data line input connector connected to a cable on the end of the first data line such that it transmits signals, and the control unit of the connecting element having a second data line input connector connected to a cable on the end of the second data line.

According to a further aspect of the invention, the control unit of the connecting element is connected to the data processing unit via a second data line of the data processing unit such that it transmits signals and is designed to receive data of the data processing unit via the second data line of the data processing unit, the control unit of the connecting element further being designed to forward the data of the data processing unit via the second data line of the drive units. For this purpose, the data that can be generated by the data processing unit can be transmitted from its control unit within the connecting element to its control unit. In the control unit of the connecting element, this data can then be forwarded directly via the second data line of the drive units to make the data of the data processing unit available for example to a superordinate central control unit.

This can preferably be carried out by the control unit of the connecting element having a second data line output connector connected to a cable on the end of the second data line such that it transmits signals, and by the data processing unit having a control unit with a second data line input connector connected to the cable of the second data line of the data processing unit such that it transmits signals.

According to a further aspect of the invention, the control unit of the connecting element is connected to the supply line such that it transmits electrical energy and is designed to receive the received electrical energy at least for operating the end effector and for operating the data processing unit. In this way, electrical energy can preferably be made available by means of an electrical supply voltage of the connecting element to at least be able to supply or operate the end effector and the data processing unit. A separate electrical supply as previously known, which leads directly to the data processing unit for example in the form of a camera and only serves to supply the latter with electricity, is thus not required. This can reduce the complexity of the lines to be used or their thickness as previously described. Electrical disturbances to the signal transmission can also be avoided. Instead, the electrical supply of the data processing unit can be carried out directly by the end effector unit or the connecting element.

This can preferably be carried out by the control unit of the connecting element having a supply line input connector connected to a cable of the supply line such that it transmits electrical energy.

As an alternative or in addition, this can preferably be carried out in that the control unit of the connecting element has a supply line output connector connected to a cable of a supply line of the data processing unit such that it transmits electrical energy and in that a control unit of the data processing unit has a supply line input connector connected to the cable of the supply line of the data processing unit such that it transmits electrical energy.

According to a further aspect of the invention, the control unit of the connecting element is designed to receive the electrical energy of the supply line with a first voltage and from the latter to generate electrical energy of a second, preferably lower, voltage, the control unit of the connecting element further being designed to operate the data processing unit with the generated second voltage. In other words, the electrical voltage which serves as a second electrical voltage for the supply or the operation of the data processing unit can be directly generated by the control unit of the connecting element. Due to the short length of the transmission of this second electrical voltage in the region of the end effector unit or of the connecting element, a high stability of the voltage supply of the data processing unit can be achieved.

Here it should be noted that for previously known cameras arranged on the end effector, their voltage is supplied via the wires of an electrical supply line that is integrated into the known data line. In addition to disturbance of the data transmission as previously described, this can also lead to the voltage present on the camera having to be kept stable over the large stretch of the known data line, which can lead to corresponding complexity. This can also lead to additional electrical interference in the data transmission.

If the second electrical voltage required to supply the data processing unit is first generated according to the invention by the control unit of the connecting element “on location”, a stable voltage supply can be guaranteed by simple means. As previously described, electrical interference along the second data line, which can lead to problems of electromagnetic compatibility (EMC), can also be avoided.

According to a further aspect of the invention, the multi-limb actuated kinematics have a base designed to be arranged fixed on a foundation, the base being connected to a drive unit of the serial kinematic chain of the drive units on one end, a control unit of the base being connected to the first data line such that it transmits signals and being designed to forward data via the first data line, the control unit of the base further being connected to the second data line such that it transmits signals and being designed to forward data via the second data line. A base can thus be created from which the drive units of the multi-limb actuated kinematics can extend away as a serial kinematic chain and in relation to which the drive units can carry out movements. For this purpose, the base can be fixed in space or arranged to be mobile in a moveable manner on a driveable plinth. Both the first data line and the second data line, preferably further a supply line, can always be guided away over the base as previously described to be able to produce the corresponding connections between the lines and, for example, a superordinate central control unit.

This can preferably be carried out by the control unit of the base having a first data line input connector connected to the cable of the first data line such that it transmits signals, and by the control unit of the base having a first data line output connector connected to the cable of the first data line such that it transmits signals.

In addition or as an alternative, this can preferably be carried out by the control unit of the base having a second data line input connector connected to the cable of the second data line such that it transmits signals, and by the control unit of the base having a second data line output connector connected to the cable of the second data line such that it transmits signals.

As an alternative or in addition, this can preferably be carried out in that the control unit of the base has a supply line input connector connected to a cable of a supply line of a superordinate central control unit such that it transmits electrical energy and in that the control unit of the base has a supply line output connector connected to the cable of a supply line such that it transmits electrical energy.

According to a further aspect of the invention, the control unit of the base is designed to receive data via the second data line, preferably from the data processing unit, and to forward said data with an amplified signal via the second data line, preferably to the outside. In this way, the signals of the data, which reach the control unit of the base via the second data line, can be forwarded or sent to the outside amplified, for example to a superordinate central control unit, which can improve or guarantee the quality of the signal transmission over longer stretches.

According to a further aspect of the invention, the drive units respectively have a hollow shaft and precisely the first data line and the second data line, and preferably the supply line, extend through the hollow shaft. In this way, the corresponding lines can be guided through the hollow shaft to connect the control units of the drive units to one another as previously described. This can in particular be a simple way to connect the control units for drive units that can carry out rotational movements. By the use according to the invention of at least the two data lines and preferably in addition of a supply line, the installation space required within the hollow shafts can be kept comparatively low, which can either enable the use of hollow shafts having a comparatively small diameter or offer the lines a comparatively large installation space, whereby the mechanical loads of the lines due to rubbing against one another and/or against the inner surface of the hollow shaft can be reduced in relation to known multi-limb actuated kinematics having hollow shafts. Finally, the lifespan of the lines, and thus the availability of the multi-limb actuated kinematics can be increased.

According to a further aspect of the invention, the multi-limb actuated kinematics are robots, preferably an articulated arm robot. The previously described properties and advantages for a robot such as in particular for an articulated arm robot or for an industrial robot can thus be implemented and applied.

According to a further aspect of the invention, the first data line is a bus. With regard to the first data line, a bus is understood as a system for transmitting data between the control units of the drive units as participants in the shared bus system or buses via the first data line as a shared transmission path. Such a bus can preferably be executed as an EthemetCAT bus. The properties and advantages of a bus system or buses for connecting the control units of the drive units such that they transmit signals can thus be used.

According to a further aspect of the invention, the second data line is a USB line. A USB line is understood as a line according to the USB standard. In this way, data processing units such as an image processing unit of the end effector unit or a superordinate central control unit can respectively be connected to both ends of the second data line according to the USB standard. This can in particular enable the use of known and simple and cost-effectively available data processing units in the end effector unit, which themselves have a USB interface. A large selection of cost-effective and high-performance data processing units can thus be simply and directly used in particular in the end effector unit, which increase the possibilities of the multi-limb actuated kinematics and simultaneously keep the costs and the complexity of the latter low.

The present invention also relates to a drive unit for use in multi-limb actuated kinematics as previously described, the drive unit being designed to be connected to at least one further drive unit to form a serial kinematic chain, the drive unit having a control unit, which is designed to operate at least one drive of the drive unit to carry out a movement of the drive unit, the control unit further being designed to be connected to the further drive unit by a first data line such that it transmit signals, and being designed to receive at least data for operating the drive via the first data line, the control unit further being designed to be connected to the further drive unit such that it transmits signals via a second line and to forward the data of the second data line. In this way, a drive unit can be made available to be able to implement multi-limb actuated kinematics as previously described and to achieve the properties and advantages thereof.

The present invention also relates to a control unit for use in a drive unit as previously described, the control unit being designed to actuate at least one drive of the drive unit to carry out the movement of the drive unit, the control unit further being designed to be connected to a further drive unit by a first data line such that it transmit signals, and being designed to receive at least data for operating the drive via the first data line, the control unit further being designed to be connected to the further drive unit such that it transmits signals via a second line and to forward the data of the second data line. In this way, a control unit can be made available to be able to implement a drive unit as previously described and to achieve its properties and advantages.

In other words, the present invention is based on the knowledge that known industrial robots usually consist of several drive units having decentralised regulation units that usually communicate with one another via a field bus. In the field of collaborative robotics, these are in particular serial modbus and EtherCAT communication. This communication is intended to transmit the robot information, and allows the transmission only of a few additional data quantities for further uses such as for external devices able to expand the functions of the robot, but do not affect the movement of the robot being carried out.

Cameras on the robot arm can be used for new fields of use and for the perception of the environment. As the internal field bus, as previously depicted, cannot usually transmit or make sufficient data quantities available, external cables are frequently laid along the robot arm. Such an external cable laid outside along the robot structure can however represent a danger for the process because other objects or people can become caught in the cable loop. Such cables are additionally usually laid manually, which can be complex. Such cables can also limit the freedom of movement and the working space of the robot.

A further possibility also consists of thus laying an additional cable through the robot arm. This additional communication cable for the external device can only be achieved with difficulty, however, as when using a hollow shaft gearing, only a limited installation space can be present for guiding the cable, through which the present supply lines and the communication cable for the field bus can already be guided and which can substantially fill the installation space of the hollow shaft. A further cable of an external device can increase the stiffness of the cable harness and it can lead to a risk of a cable breaking or to a reduced lifespan of the shielded cables.

Against this background, it can be desirable to achieve a simplified cable guidance for the connection and bi-directional communication of sensors or actuators, such as cameras, lighting, storage devices, grippers and the like as external devices on an industrial robot. The movement of the robot should not be limited as far as possible, and as little danger as possible should arise for the process.

According to the invention, a communication cable for the external device can be guided through the robot arm so that no cable runs externally to the robot. A risk could thus arise as previously described that people or objects could become caught in existing cable loops. Thus, according to the invention, the communication cable for the external device can run within the robot from control unit to control unit of the individual drive units, and can preferably be separated by a pluggable connection in each drive unit. The construction of the robot arm can thus be simplified, as the robot does not have to be constructed along a stiff cable. On the other hand, drive units for assembly or repair can thus be removed more easily. A shared shield of the data cables can also be provided.

According to the invention, a camera or another component as an external device can thus be built into a media flange as last active component of the robot. For this purpose, a conventional USB camera can be used, with other cameras or other external devices also being conceivable. To be able to adjust the focus of the camera during the process, a liquid lens can be installed in front of the camera. Depending on the camera position, the camera image can thus be automatically focused. The camera can be protected from the intrusion of dust and liquids by an O ring and a disk.

The USB cable of the camera can be connected to the control unit of the media flange. The USB cable can consist of four conductors in total and have two conductors for the electrical supply (5V and GND) and two communication conductors or data conductors (Rx and Tx) that can together form an additional, second data line.

The USB signal of the camera can be disconnected on the control unit of the media flange. The two supply lines (5V and GND) can be connected to a circuit that can be generated on the control unit of the media flange. It would also be technically possible to generate this supply voltage on another control unit within the robot structure. A stable voltage supply can always be implemented via the adjusted voltage supply despite a large distance between the USB source and target, such as a superordinate central control unit of the robot, such that an EMC-stable electrical supply of the USB camera can be ensured. It can thus additionally be avoided that the two supply lines of the USB camera have to be guided through the robot arm, whereby the number of necessary conductors or lines can be reduced. A smaller hollow shaft can thus be used in the drive units. If a larger hollow shaft is used, this can cause friction between the cables of the lines and the hollow shaft, whereby less rubbing and a longer lifespan of the cable of the lines can be achieved.

The two communication conductors (Rx and Tx) of the additional, second data line can be guided together with the communication conductors of the field bus (EtherCat, 4 conductors) as a first data line together with a shield in a communication cable through the hollow shaft of the sixth drive unit.

In each drive unit, the communication cable (consisting of the four EtherCAT conductors of the first data line and the two USB conductors (Rx and Tx) of the second data line) can be connected to the control unit of the respective drive unit. The field bus signals (EtherCat) of the first data line can here be used for communication between the control units, and the USB communication conductors of the second data line can be forwarded. The two signal types (EtherCAT and USB) can thus be physically separated from one another, such that a higher bandwidth is available during the data communication and a lower risk of data loss can be taken into account in a risk analysis.

From this sixth, last drive unit, the communication cable can lead to the next drive unit with the two data lines and from there can there lead in the same way to the first drive unit.

The communication cable can lead from the first drive unit to the base of the robot with the two data lines. The robot can be screwed to a surface with the base. A connection between the robot arm and the robot controller or a switchboard for the robot cable can additionally be mounted on the base.

To amplify the USB signal, an additional circuit board can be built into the base. A USB hub component for outputting data can be located on this circuit board, which component can filter interference out of the USB signal and/or ensure a stable connection.

A standard twisted pair cable (network cable) of category 6 can then lead from the circuit board in the robot base into the robot cable. In this cable, four conductors can be used for the field bus of the first data line, and two further conductors can be used for the USB communication of the second data line. The robot cable can be connected to the robot controller (switchboard) with an RJ45 plug. In the robot controller, the network cable with the two data lines can be connected to the control unit of the robot controller as a superordinate central control unit. There or even before, the conductors of the network cable of the two data lines can be divided up and the two USB conductors of the second data line can be fed to a USB plug. Via this plug, the USB signal of the second data line can be connected to the USB target (control computer).

This solution according to the invention can offer several advantages. A USB interface can enable the connection of industrial and user components, such that a large number of cost-effective and high-performance add-ons can be connected to the robot. The construction can be carried out cost-effectively, as standard components can be used. Via the altered voltage supply of the media flange and/or via the amplifier component of the base, an EMC-robust solution can be achieved. The construction can be easily assembled with the plug-in processes in the robot arm and the robot arm can be maintenance-friendly. It is also conceivable to vary the number of drive units used due to this construction.

An exemplary embodiment and further advantages of the invention are depicted purely schematically and explained in more detail in the following in connection with the following figures. Here:

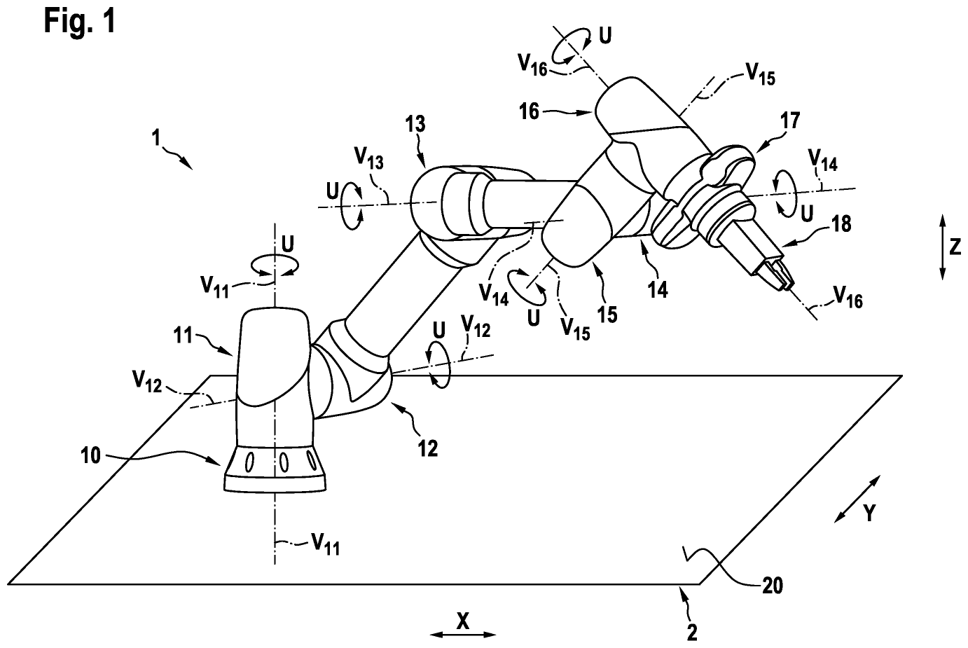

FIG. 1 shows a perspectival schematic depiction of multi-limb actuated kinematics according to the invention;

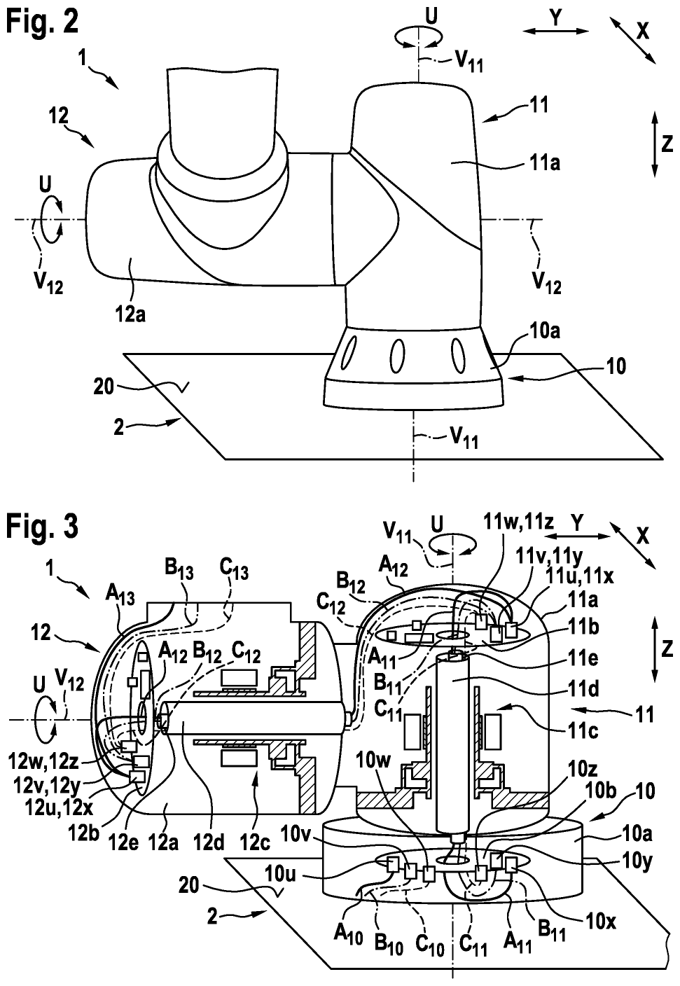

FIG. 2 shows a portion of FIG. 1 in the region of the base;

FIG. 3 shows a schematic cross-section of the view of FIG. 2;

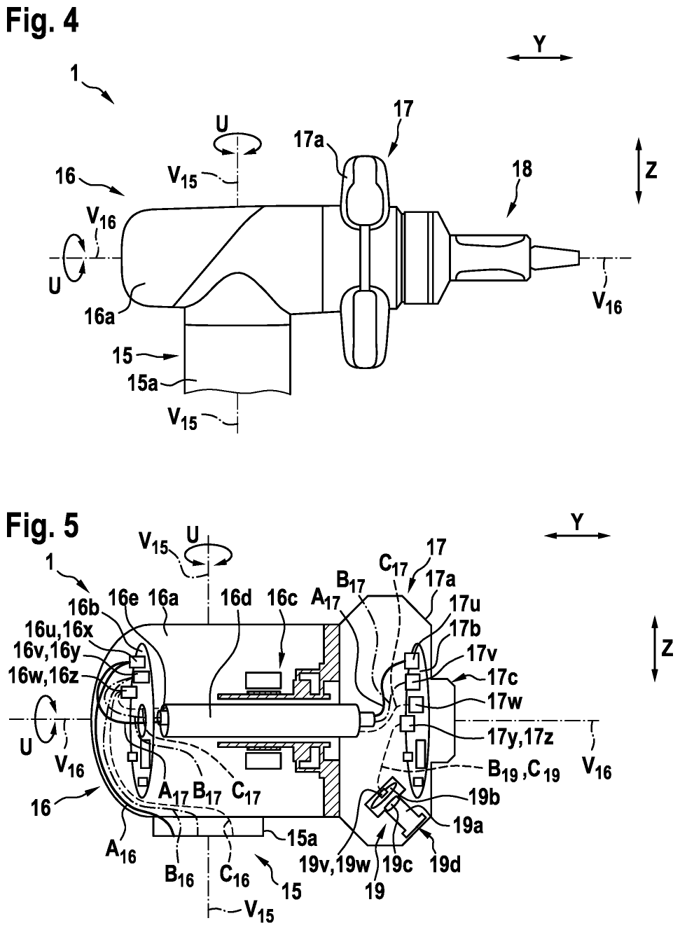

FIG. 4 shows a portion of FIG. 1 in the region of the end effector unit;

FIG. 5 shows a schematic cross-section of the view of FIG. 4;

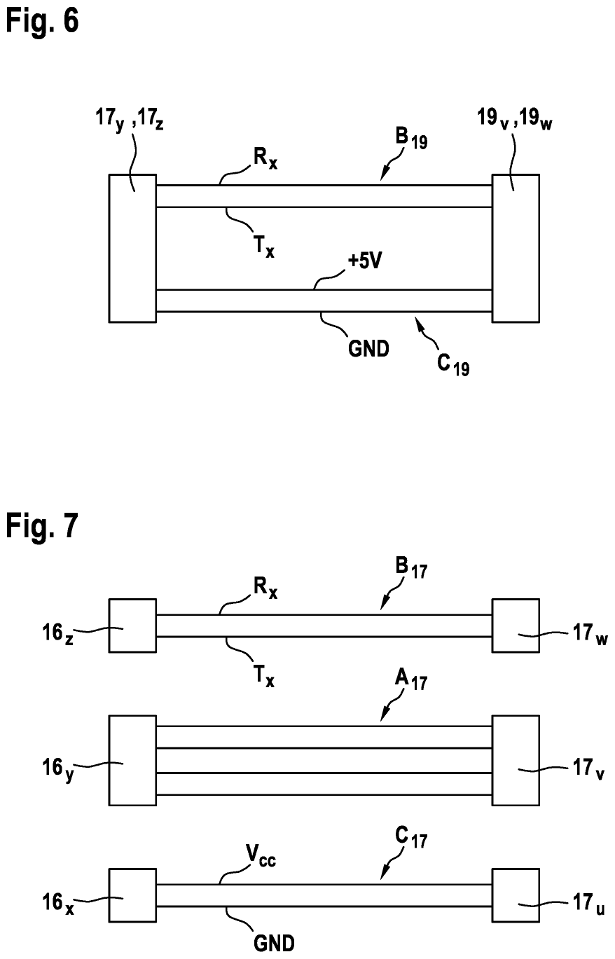

FIG. 6 shows a schematic depiction of the cable of the second data line and of the cable of the supply line of the connecting element; and

FIG. 7 shows a schematic depiction of the cable of the first data line, the second data line and the supply line of the sixth drive units.

The Figures specified above are viewed in Cartesian coordinates. A longitudinal direction X extends, which can also be described as a depth X or as a length X. A transverse direction Y, which can also be described as a width Y, extends perpendicular to the longitudinal direction X. A vertical direction Z, which can also be described as a height Z and corresponds to the direction of gravity, extends perpendicular both to the longitudinal direction X and to the transverse direction Y. The longitudinal direction X and the transverse direction Y together form the horizontals X, Y, which can also be described as a horizontal plane X, Y.

Multi-limb actuated kinematics 1 according to the invention in the form of a robot 1 or in the form of an articulated arm robot 1 are considered as an example, see for example FIG. 1. The articulated arm robot 1 has a base 10 arranged fixed in the vertical direction Z on a foundation surface 20 of a foundation 2. Six drive units 11-16 extend one behind the other away from the base 10 as a serial kinematic chain. A connecting element 17 is arranged on the sixth drive unit 16 as the outermost limb of the serial kinematic chain, said connecting element receiving an end effector 18 in the form of a gripper exchangeably fixed on itself. The connecting element 17 can thus also be described as a media flange 17, as an end effector flange 17, as a tool flange 17 or as a gripping flange 17. The connecting element 17 and the end effector 18 together form an end effector unit 17, 18.

The six drive units 11-16 respectively have an electrical drive 11c, 12c, 16c that can respectively move a partial region on the drive side in relation to a partial region on the output side of the corresponding drive unit 11-16 rotationally in relation to each other. The six drive units 11-16 can thus respectively be rotated around a rotational axis V₁₁-V₁₆ in a rotation direction U or turning direction U, see for example FIG. 1.

The base 10 has a housing 10a enclosing the components of the base 10 laterally outwards and protects them from the surroundings, see for example FIGS. 2 and 3. Within the housing 10a, a control unit 10b of the base 10 is arranged, which is depicted assembled as a circuit board having electronic components. Via a first data line input connector 10u, the control unit 10b of the base 10 is connected to a cable A₁₀ of a first data line A₁₀, A₁₁, A₁₂, A₁₃, A₁₆, A₁₇ such that it transmits signals. Via the cable A₁₀ of the first data line A₁₀, A₁₁, A₁₂, A₁₃, A₁₆, A₁₇, data in the form of instructions, commands or control data can be transmitted from a superordinate central control unit (not depicted) to the control unit 10b of the base 10 which can both be implemented there and forwarded via the first data line output connector 10x of the base 10.

The control unit 10b of the base 10 further has a second data line input connector 10v, which is connected to a cable B₁₀ of a second data line B₁₀, B₁₁, B₁₂, B₁₃, B₁₆, B₁₇, B₁₉ such that it transmits signals. Via the cable B₁₀ of the second data line B₁₀, B₁₁, B₁₂, B₁₃, B₁₆, B₁₇, B₁₉, data in the form of information or sensor data, which can in particular be image data, can be received from the control unit 10b of the base 10 via a second data line output connector 10y of the base 10 and be transmitted to the superordinate central control unit to there be processed and used.

The control unit 10b of the base 10 further has a supply line input connector 10w, which is electrically connected to a cable C₁₀ of a supply line C₁₀, C₁₁, C₁₂, C₁₃, C₁₆, C₁₇, C₁₉. Via the cable C₁₀, of the supply line C₁₀, C₁₁, C₁₂, C₁₃, C₁₆, C₁₇, C₁₉, electrical energy in the form of electrical voltage can be made available to the control unit 10b of the base 10 via the superordinate central control unit to supply it with electricity itself or to operate the control unit 10b of the base 10 and to forward the electrical voltage via a supply line output connector 10z of the base 10.

The first drive unit 11 also has a housing 11a. Within the housing 11a of the first drive unit 11, a control unit 11b is arranged, which is also depicted assembled as a circuit board having electronic components. The control unit 11b of the first drive unit 11 also has a first data line input connector 11u connected to the first data line output connector 10x of the control unit 10b of the base 10 via a cable A₁₁ of the first data line A₁₀, A₁₁, A₁₂, A₁₃, A₁₆, A₁₇ such that it transmits signals. Via the cable A₁₁ of the first data line A₁₀, A₁₁, A₁₂, A₁₃, A₁₆, A₁₇, the control data of the superordinate decentralised control unit can be forwarded from the control unit 10b of the base 10 to the control unit 11b of the first drive unit 11 to itself be implemented there or to be forwarded via a first data line output connector 11x of the control unit 11b of the first drive unit 11.

The control unit 11b of the first drive unit 11 further has a second data line input connector 11v connected to the second data line output connector 10y of the control unit 10b of the base 10 via a cable B₁₁ of the second data line B₁₀, B₁₁, B₁₂, B₁₃, B₁₆, B₁₇, B₁₉ such that it transmits signals. Via the cable B₁₁ of the second data line B₁₀, B₁₁, B₁₂, B₁₃, B₁₆, B₁₇, B₁₉, data originating from a data processing unit 19 can be received from the control unit 11b of the first drive unit 11 via a second data line output connector 11y of the first drive unit 11 and be transmitted or forwarded to the control unit 10 of the base 10.

The control unit 11b of the first drive unit 11 further has a supply line input connector 11w connected to the supply line output connector 10z of the control unit 10b of the base 10 via a cable C₁₁ of the second data line C₁₀, C₁₁, C₁₂, C₁₃, C₁₆, C₁₇, C₁₉ such that it conducts electricity. Via the cable C₁₁ of the supply line C₁₀, C₁₁, C₁₂, C₁₃, C₁₆, C₁₇, C₁₉, electrical energy can be made available to the control unit 11b of the first drive unit 11 by means of an electrical voltage of the control unit 10b of the base 10 to supply it with electricity itself or to operate the control unit 11b of the base 11 and to forward the electrical voltage via a supply line output connector 11z of the first drive unit 11.

The cable A₁₁ of the first data line A₁₀, A₁₁, A₁₂, A₁₃, A₁₆, A₁₇ and the cable B₁₁ of the second data line B₁₀, B₁₁, B₁₂, B₁₃, B₁₆, B₁₇, B₁₉ are surrounded by a shared shield 11e, within which only the cable A₁₁ of the first data line A₁₀, A₁₁, A₁₂, A₁₃, A₁₆, A₁₇ and the cable B₁₁ of the second data line B₁₀, B₁₁, B₁₂, B₁₃, B₁₆, B₁₇, B₁₉ are arranged. The signal transmission via the cable A₁₁ of the first data line A₁₀, A₁₁, A₁₂, A₁₃, A₁₆, A₁₇ and the cable B₁₁ of the second data line B₁₀, B₁₁, B₁₂, B₁₃, B₁₆, B₁₇, B₁₉ can thus be protected from electrical interference, which can improve or guarantee the quality of the signal transmission.

Both the cable A₁₁ of the first data line A₁₀, A₁₁, A₁₂, A₁₃, A₁₆, A₁₇ and the cable B₁₁ of the second data line B₁₀, B₁₁, B₁₂, B₁₃, B₁₆, B₁₇, B₁₉ within their shield 11e and the cable C₁₁ of the supply line C₁₀, C₁₁, C₁₂, C₁₃, C₁₆, C₁₇, C₁₉ run together in parallel through the hollow shaft 11d of the drive 11c of the first drive unit 11. In this way, a cable-bound connection between the control unit 10b of the base 10 and the control unit 11b of the first drive unit 11 can be achieved, which can also permit the rotational movements.

The second drive unit 12 is designed and connected to the first drive unit 11 in the same way, see also for example FIGS. 2 and 3. This also applies to the third drive unit 13, to the fourth drive unit 14, to the fifth drive unit 15 and to the sixth drive unit 16, which is depicted for example in FIGS. 4 and 5. The corresponding elements are described consecutively and consistently and provided with reference numerals, such that, to avoid repetition, it is not necessary to go into the second to sixth drive unit 12-16 in more detail.

The connecting element 17, which has a housing 17a in turn, is rotatably moveably connected to the sixth drive unit 16. An end effector connector 17c is designed on the housing 17a of the connecting element 17 for fixing the end effector 18.

The connecting element 17 further has the data processing unit 19 already mentioned, which is designed as an image recording unit 19 or as a camera 19 and aligned with its optics 19d to the region ahead of the end effector 18. The image recording unit 19 itself has a housing 19a that encloses a control unit 19b of the image processing unit 19 as a circuit board assembled with electronic components. The control unit 19b of the image recording unit 19 is connected to an image recording sensor 19c of the image recording unit 19 such that it transmits signals (not depicted). The image recording sensor 19c can record the region in front of the end effector 18 through the optics 19d. The information recorded by sensor can be transmitted or sent out as optical data or as image data by the control unit 19b of the image recording unit 19, as is explained in more detail in the following.

The connecting element 17 also has a control unit 17b as a circuit board assembled with electronic components. The cable A₁₇ of the first data line A₁₀, A₁₁, A₁₂, A₁₃, A₁₆, A₁₇ is connected to the first data line input connector 17u of the control unit 17b of the connecting element 17 such that it transmits signals, such that the control data can also reach the control unit 17b of the connecting element 17. The control data can there be used to actuate or operate the end effector 18. The control data can also serve to actuate or operate the image recording unit 19.

Thus, a continuous arrangement of the first data line A₁₀, A₁₁, A₁₂, A₁₃, A₁₆, A₁₇ from the base 10 to the connecting element 17 can be achieved, which is formed by the individual cables A₁₀, A₁₁, A₁₂, A₁₃, A₁₆, A₁₇ of the first data line A₁₀, A₁₁, A₁₂, A₁₃, A₁₆, A₁₇ that together thus represent the first data line A₁₀, A₁₁, A₁₂, A₁₃, A₁₆, A₁₇. In particular, a bus, for example an EtherCAT bus, can thus be formed, which connects the control units 10b, 11b, 12b, 16b, 17b of the base 10, the drive units 11-16 and the connecting element 17 to one another such that they transmit signals. The respective control units 10b, 11b, 12b, 16b, 17n can thus be provided with control data and thus be controlled or operated. Control data meant for other control units 10b, 11b, 12b, 16b 17b can be forwarded from the respective control unit 10b, 11b, 12b, 16b, 17b.

The cable B₁₇ of the second data line B₁₀, B₁₁, B₁₂, B₁₃, B₁₆, B₁₇, B₁₉ is connected to a second data line input connector 17v of the control unit 17b of the connecting element 17 such that it transmits signals. The image data of the image recording unit 19 can be transmitted to a second data line output connector 17y of the control unit 17b of the connecting element 17 via a second data line input connector 19v of the control unit 19b of the data processing unit 19 via a cable B₁₉ of the second data line B₁₀, B₁₁, B₁₂, B₁₃, B₁₆, B₁₇, B₁₉. The image data can then be transmitted via all further cables B₁₀, B₁₁, B₁₂, B₁₃, B₁₆, B₁₇ of the second data line B₁₀, B₁₁, B₁₂, B₁₃, B₁₆, B₁₇, B₁₉ to the superordinate central control unit by the control unit 17b of the connecting element 17. A signal amplification can take place in the control unit 10b of the base 10 before the image data is forwarded so that the image data can reach the superordinate central control unit with a sufficient strength and quality.

As data can also be transmitted in the opposite direction from the superordinate central control unit to the control unit 19b of the image processing unit 19 via the second data line B₁₀, B₁₁, B₁₂, B₁₃, B₁₆, B₁₇, B₁₉, the corresponding connections of the control units 10b, 11b, 12b, 16b, 17b, 19b to the base 10, the drive units 11-16, the connecting element 17 and the image recording unit 19 can be described as input connections or output connections in accordance with the corresponding connections of the first data line A₁₀, A₁₁, A₁₂, A₁₃, A₁₆, A₁₇.

The cable C₁₆ of the supply line C₁₀, C₁₁, C₁₂, C₁₃, C₁₆, C₁₇, C₁₉ is connected to a supply line input connector 17w of the control unit 17b of the connecting element 17 such that it conducts electricity, whereby the control unit 17b of the connecting element 17 can also be electrically supplied. This electrical supply can be used directly to operate the end effector 18.

The control unit 17b of the connecting element 17 further has a voltage transformer (not depicted) that receives the electrical voltage directly from the cable C₁₇ of the supply line C₁₀, C₁₁, C₁₂, C₁₃, C₁₆, C₁₇, C₁₉ and this electrical voltage is transformed into a second, lower electrical voltage. The second, lower electrical voltage is then guided via a supply line output connector 17z of the control unit 17b of the connecting element 17 via a cable C₁₉ of the supply line C₁₀, C₁₁, C₁₂, C₁₃, C₁₆, C₁₇, C₁₉ to a supply line input connector 19w of the control unit 19b of the image processing unit 19, so that the control unit 19b of the image processing unit 19 can be supplied and operated with the second, lower electrical voltage. In this way, due to a short stretch between the voltage transformer of the image processing unit 19 and its control unit 19b, a stable electrical voltage can be made available at the appropriate voltage level. Problems with the stable voltage transmission, for example from the superordinate central control unit, can thus be avoided.

FIG. 6 shows a schematic depiction of the cable B₁₉ of the second data line B₁₀, B₁₁, B₁₂, B₁₃, B₁₆, B₁₇, B₁₉ and of the cable C₁₉ of the supply line C₁₀, C₁₁, C₁₂, C₁₃, C₁₆, C₁₇, C₁₉ of the connecting element 17. The cable B₁₉ of the second data line B₁₀, B₁₁, B₁₂, B₁₃, B₁₆, B₁₇, B₁₉ consists of two wires Rx, Tx or two conductors Rx, Tx having a received data line Rx and a transmitted data line Tx via which the image data of the control unit 19b of the image recording unit 19 can be be guided to the control unit 17b of the connecting element 17 as previously described.

Via an earth line GND and via a 5V voltage line +5V of the parallel-running cable C₁₉ of the supply line C₁₀, C₁₁, C₁₂, C₁₃, C₁₆, C₁₇, C₁₉ of the connecting element 17, the second, lower electrical voltage of the control unit 17b of the connecting element 17 can be fed to the control unit 19b of the image recording unit 19.

FIG. 7 shows a schematic depiction of the cable of the first data line A₁₀, A₁₁, A₁₂, A₁₃, A₁₆, A₁₇, of the second data line B₁₀, B₁₁, B₁₂, B₁₃, B₁₆, B₁₇, B₁₉ and of the supply line C₁₀, C₁₁, C₁₂, C₁₃, C₁₆, C₁₇, C₁₉ of the sixth drive units 16. The cables of the first data line A₁₀, A₁₁, A₁₂, A₁₃, A₁₆, A₁₇, of the second data line B₁₀, B₁₁, B₁₂, B₁₃, B₁₆, B₁₇, B₁₉ and of the supply line C₁₀, C₁₁, C₁₂, C₁₃, C₁₆, C₁₇, C₁₉ of the remaining drive units 11-15 and the base 10 are constructed identically.

The two wires Rx, Tx or two conductors Rx, Tx of the cable B₁₇ of the second data line B₁₀, B₁₁, B₁₂, B₁₃, B₁₅, B₁₆, B₁₇, B₁₉ continue from the control unit 17b of the connecting element 17 to the base 10 and beyond to the superordinate central control unit. The cable of the supply line C₁₀, C₁₁, C₁₂, C₁₃, C₁₅, C₁₆, C₁₇, C₁₉ also continues from the control unit 17b of the connecting element 17 to the base 10 and beyond to the superordinate central control unit, a 12V voltage line V_{cc} now running.

In addition, the cables of the first data line A₁₀, A₁₁, A₁₂, A₁₃, A₁₆, A₁₇ run from the control unit 17b of the connecting element 17 to the base 10 and beyond to the superordinate central control unit, said cables respectively having four wires or conductor which are necessary to carry out the signal transmission of a bus.

### LIST OF REFERENCE SIGNS (PART OF THE DESCRIPTION)

A₁₀ first data line or bus of the base 10 or its cable
A₁₁ first data line or bus of the first drive unit 11 or its cable
A₁₂ first data line or bus of the second drive unit 12 or its cable
A₁₃ first data line or bus of the third drive unit 13 or its cable
A₁₆ first data line or bus of the sixth drive unit 16 or its cable
A₁₇ first data line or bus of the connecting element 17 or its cable
B₁₀ second data line or USB line of the base 10 or its cable
B₁₁ second data line or USB line of the first drive unit 11 or its cable
B₁₂ second data line or USB line of the second drive unit 12 or its cable
B₁₃ second data line or USB line of the third drive unit 13 or its cable
B₁₆ second data line or USB line of the sixth drive unit 16 or its cable
B₁₇ second data line or USB line of the connecting element 17 or its cable
B₁₉ second data line or USB line of the data processing unit 19 or its cable
C₁₀ supply line of the base 10 or its cable
C₁₁ supply line of the first drive unit 11 or its cable
C₁₂ supply line of the second drive unit 12 or its cable
C₁₃ supply line of the third drive unit 13 or its cable
C₁₆ supply line of the sixth drive unit 16 or its cable
C₁₇ supply line of the connecting element 17 or its cable
C₁₉ supply line of the data processing unit 19 or its cable
GND earth line; reference potential line
+5V 5V voltage line
V_{Cc} 12V voltage line
Rx receiving data line
Tx transmitting data line
V₁₁-V₁₆ rotational axes of the drive units 11-16
U rotational or turning directions of the rotational axes V₁₁-V₁₆
X longitudinal direction; depth; length
Y transverse direction; width
Z vertical direction; height
X, Y horizontals; horizontal plane
1 multi-limb kinematics; (articulated arm) robot
10 base
10a housing of the base 10
10b control unit of the base 10
10u first data line input connector of the control unit 10b of the base 10
10v second data line input connector of the control unit 10b of the base 10
10w supply line input connector of the control unit 10b of the base 10
10x first data line output connector of the control unit 10b of the base 10
10y second data line output connector of the control unit 10b of the base 10
10z supply line output connector of the control unit 10b of the base 10
11 first drive unit
11a housing of the first drive unit 11
11b control unit of the first drive unit 11
11c drive of the first drive unit 11
11d hollow shaft of the drive 11c of the first drive unit 11
11e shield of the first drive unit 11
11u first data line input connector of the control unit 11b of the first drive unit 11
11v second data line input connector of the control unit 11b of the first drive unit 11
11w supply line input connector of the control unit 11b of the first drive unit 11
11x first data line output connector of the control unit 11b of the first drive unit 11
11y second data line output connector of the control unit 11b of the first drive unit 11
11z supply line output connector of the control unit 11b of the first drive unit 11
12 second drive unit
12a housing of the second drive unit 12
12b control unit of the second drive unit 12
12c drive of the second drive unit 12
12d hollow shaft of the drive 12c of the second drive unit 12
12e shield of the second drive unit 12
12u first data line input connector of the control unit 12b of the second drive unit 12
12v second data line input connector of the control unit 12b of the second drive unit 12
12w supply line input connector of the control unit 12b of the second drive unit 12
12x first data line output connector of the control unit 12b of the second drive unit 12
12y second data line output connector of the control unit 12b of the second drive unit 12
12z supply line output connector of the control unit 12b of the second drive unit 12
13 third drive unit
14 fourth drive unit
15 fifth drive unit
15a housing of the fifth drive unit 15
16 sixth drive unit
16a housing of the sixth drive unit 16
16b control unit of the sixth drive unit 16
16c drive of the sixth drive unit 16
16d hollow shaft of the drive 16c of the sixth drive unit 16
16e shield of the sixth drive unit 16
16u first data line input connector of the control unit 16b of the sixth drive unit 16
16v second data line input connector of the control unit 16b of the sixth drive unit 16
16w supply line input connector of the control unit 16b of the sixth drive unit 16
16x first data line output connector of the control unit 16b of the sixth drive unit 16
16y second data line output connector of the control unit 16b of the sixth drive unit 16
16z supply line output connector of the control unit 16b of the sixth drive unit 16
17, 18 end effector unit
17 connecting element; media flange; end effector flange; tool flange; gripping flange
17a housing of the connecting element 17
17b control unit of the connecting element 17
17c end effector connector of the connecting element 17
17u first data line input connector of the control unit 17b of the connecting element 17
17v second data line input connector of the control unit 17b of the connecting element 17
17w supply line input connector of the control unit 17b of the connecting element 17
17y second data line output connector of the control unit 17b of the connecting element 17
17z supply line output connector of the control unit 17b of the connecting element 17
18 end effector; gripper
19 data processing unit; image recording unit; camera
19a housing of the data processing unit 19
19b control unit of the data processing unit 19
19c image recording unit of the data processing unit 19
19d optics or lens of the data processing unit 19
19v second data line input connector of the control unit 19b of the data processing unit 19
19w supply line input connector of the control unit 19b of the data processing unit 19
2 foundation
20 foundation surface

1.-11. (canceled)

12. A multi-limb actuated kinematics device, comprising:
a plurality of drive units connected to one another as a serial kinematic chain, the plurality of drive units each operably coupled to a control unit designed to actuate at least one drive of the plurality of drive units to carry out movement of one of the plurality of drive units, the control units of the plurality of drive units being connected to one another by a first data line such that the control units transmit signals and are designed to receive at least data configured to operate the drive via the first data line, the control units of the plurality of drive units further operably connected to one another via a supply line; and
a connecting element connected to the drive unit at one end of the serial kinematic chain, the connecting element including at least one data processing unit selected from an image recording unit and a control unit, the control unit of the connecting element being connected to the first data line, which serves to transmit data for controlling the data processing unit, the control unit of the connecting element further being connected to a second data line, which serves to transmit data of the data processing unit, the control units of the drive units further being connected to one another by the second data line such that the control units transmit signals, and are designed to transmit the data of the second data line, and the data processing unit is adapted to operably couple to an energy source such that a supply voltage is generated in a control unit within the actuated kinematics.

13. The multi-limb actuated kinematics device according to claim 12, wherein the first data line is formed between two immediately neighboring control units of the plurality of drive units by at least one cable, the second data line is formed between two immediately neighboring control units of the plurality of drive units by at least one second cable and the cable of the first data line and the second cable of the second data line are at least partially surrounded by a shared shield.

14. The multi-limb actuated kinematics device according to claim 12, wherein the control unit of the connecting element is designed to receive electrical energy of the supply line with a first voltage and from the latter to generate electrical energy of a second, lower voltage, the control unit of the connecting element further being designed to actuate the data processing unit with the generated second voltage.

15. The multi-limb actuated kinematics device according to claim 12, further comprising:
a base secured on a foundation and operably connected to one of the plurality of drive units at an end of the serial kinematic chain, the base including a control unit connected to the first data line configured to transmit signals and data via the first data line, the control unit of the base further connected to the second data line such that the control unit of the base is configured to transmits signals and transmit data via second data line.

16. The multi-limb actuated kinematics device according to claim 15, wherein the control unit of the base is designed to receive data via the second data line from the data processing unit and transmit the data with a strengthened signal via second data line therefrom.

17. The multi-limb actuated kinematics device according to claim 12, wherein the plurality of drive units includes a hollow shaft, the first data line, the second data line, and the supply line configured to run therethrough.

18. The multi-limb actuated kinematics device according to claim 12, wherein the multilimb actuated kinematics device is an articulatable robot.

19. The multi-limb actuated kinematics device according to claim 12, wherein the first data line is a bus.

20. The multi-limb actuated kinematics device according to claim 12, wherein the second data line is a USB line.

21. The multi-limb actuated kinematics device according to claim 12, wherein one of the plurality of drive units is designed to be connected to at least one further drive unit to form a serial kinematic chain, the at least one further drive unit having a control unit, which is designed to actuate at least one drive of the plurality of drive units to carry out movement of the plurality of drive units,
the control unit further being designed to be operably connected to the further drive unit by a first data line such that the control unit transmits signals and receives at least data for operating the drive via the first data line,
the control unit further being designed to be operably connected to the further drive unit by a second data line such that the control unit transmits signals and data of the second data line.

22. The multi-limb actuated kinematics device according to claim 21, wherein the control unit is designed to actuate at least one drive of the plurality of drive units to carry out the movement of the plurality of drive units,
the control unit further being designed to be operably connected to a further drive unit by a first data line such that the control unit transmits signals and receives at least data for operating the drive via the first data line,
the control unit further being designed to be operably connected to the further drive unit by a second data line such that the control unit transmits signals and transmits data of the second data line.
